(19) United States
(12) Patent Application Publication
(10) Pub. No.: US 2010/0003550 A1
(43) Pub. Date: Jan. 7, 2010

(54) FUEL CELL DEVICE AND METHOD FPR REGULATING FUEL SUPPLY TO FUEL CELL DEVICE

(75) Inventor: Masaki SATO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/392,214

(22) Filed: Feb. 25, 2009

(30) Foreign Application Priority Data
Jul. 4, 2008 (JP) 2008175548

(51) Int. Cl. H01M 8/04

(52) U.S. Cl. 429/13; 429/23

(57) ABSTRACT

A fuel cell device having a fuel cell, a pump, an inhalation/exhalation port and a controller is provided. The pump is configured to regulate fuel supply to the fuel cell. The inhalation/exhalation port is configured to inhale oxygen and exhale moisture into and from the fuel cell, respectively. The controller is configured to open and close the inhalation/exhalation port, the controller being configured to control the pump so as to supply the fuel cell with fuel while the inhalation/exhalation port is closed in such a way that the fuel cell keeps an output voltage equal to or around a determined threshold value.

### CROSS REFERENCE TO RELATED APPLICATIONS

This application is based upon and claims the benefit of priority from the prior Japanese Patent Application No. 2008-175548 filed on Jul. 4, 2008;

the entire contents of which are incorporated herein by reference.

### BACKGROUND OF THE INVENTION

1. Field of the Invention

The present invention relates to a fuel cell device and a method for regulating fuel supply to the fuel cell device, and in particular to a fuel cell device that can be used for an electronic apparatus such as a mobile phone.

2. Description of the Related Art

It is generally known that a fuel cell device has a fuel cell, a fuel tank for storing hydrogen or ethanol, a pump for regulating fuel supply from the fuel tank to the fuel cell, an inhalation/exhalation port for both inhaling oxygen (air) to the fuel cell and exhaling moisture from the cell, and an inhalation/exhalation valve for opening and closing the inhalation/exhalation port. For electric power generation, the fuel cell device supplies the fuel cell with fuel from the fuel tank, opens the inhalation/exhalation port and combines hydrogen and oxygen so as to generate electric power and water. While generating no power, the fuel cell device stops supplying the fuel and closes the inhalation/exhalation port so as to stop supplying hydrogen and oxygen.

Such a fuel cell device is included in a mobile phone, as disclosed in, e.g., Japanese Patent Publication of Unexamined Applications (Kokai), No. 2007-88804. It is not described in JP 2007-88804 that the fuel cell device has an inhalation/exhalation port or an inhalation/exhalation valve.

As the mobile phone of JP 2007-88804 has a flip type housing structure, a power level required by the mobile phone or a condition of how the mobile phone is carried by a user may change depending upon whether the flip type housing is open or closed. Thus, if the housing is open, the fuel cell device generates power, charges a rechargeable battery and generates moisture as a result of the power generation. If the housing is closed, the fuel cell device stops generating power and generates no moisture.

The mobile phone of JP 2007-88804 is configured to exhale the moisture through an exhalation hole arranged in one of sections of the flip type structure having a display unit. The fuel cell device of JP 2007-88804 is configured to regulate an amount of the fuel supply to the fuel cell by using a governor so as to control an amount of the generated power. It is also described that the fuel cell device is configured to continuously operate if the charged power level of the rechargeable battery is exceptionally low.

Even after the fuel cell device stops generating power, the supplied fuel remains in the fuel cell. Thus, as a matter of fact, the fuel cell device continues generating power although slightly, due to leakage of air and so on even if the inhalation/exhalation port is closed. After time passes, the fuel that remained in the fuel cell is exhausted, and the fuel cell becomes dry.

In a case where the fuel cell device generates power starting from the condition in which the fuel cell is dry, the fuel cell device does not give full scope to its ability to generate power until fuel supplied to the fuel cell spreads all over the cell. It takes several to dozens of minutes, and thus causes a problem that the fuel cell device is unable to generate enough power immediately.

Such a problem of the fuel cell being dry, or how to cope with the above problem, is not described in JP 2007-88804 which probably assumes a good condition in which the fuel cell is not dry.

### SUMMARY OF THE INVENTION

Accordingly, an advantage of the present invention is to provide a fuel cell device configured to control fuel supply so as to cope with a problem of a fuel cell being dry, to prevent the fuel cell from being dry, and to start working immediately even after a long time off.

To achieve the above advantage, one aspect of the present invention is to provide a fuel cell device having a fuel cell, a pump, an inhalation/exhalation port and a controller. The pump is configured to regulate fuel supply to the fuel cell. The inhalation/exhalation port is configured to inhale oxygen and exhale moisture into and from the fuel cell, respectively. The controller is configured to open and close the inhalation/exhalation port, the controller being configured to control the pump so as to supply the fuel cell with fuel while the inhalation/exhalation port is closed in such a way that the fuel cell keeps an output voltage equal to or around a determined threshold value.

### BRIEF DESCRIPTION OF THE DRAWINGS

FIG. 1 is a block diagram of a fuel cell device 100 of an embodiment of the invention.

FIGS. 2A-2C illustrate an experiment with respect to a relation between the extent to which the inside of a fuel cell 6 of the embodiment is dry and a rise time of an output voltage of the fuel cell 6.

FIG. 3 is a flowchart of a control operation performed by a controller 10 of the fuel cell device 100 of the embodiment.

FIGS. 4A-4C are timing charts for illustrating the control operation performed by the controller 10 of the fuel cell device 100 of the embodiment.

### DETAILED DESCRIPTION OF THE INVENTION

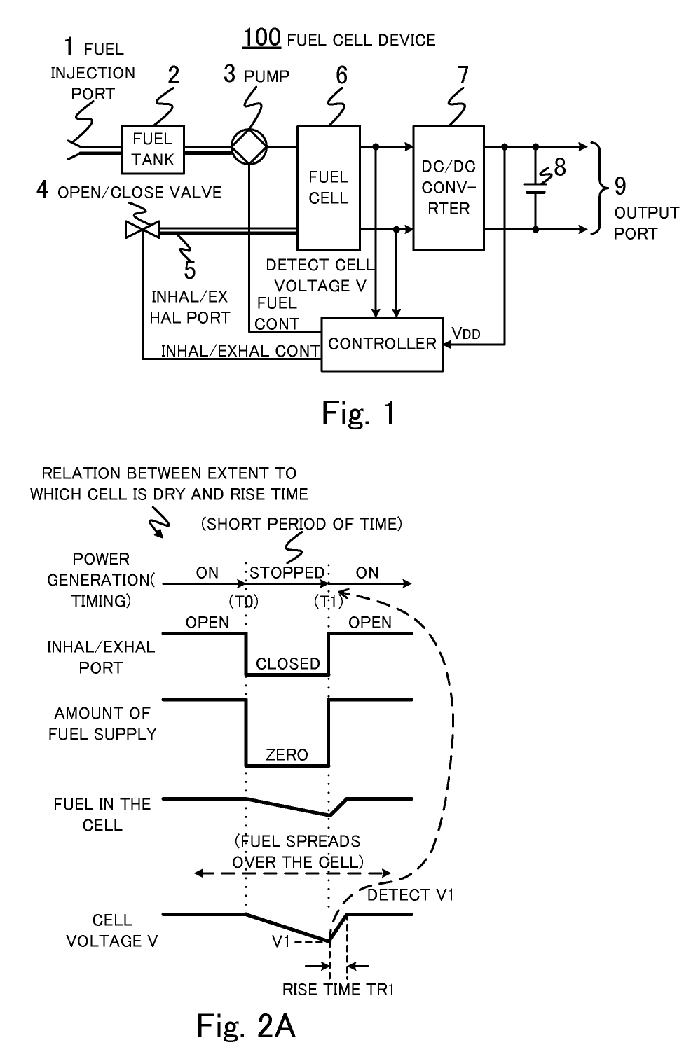

An embodiment of the present invention will be described with reference to FIGS. 1-4C. FIG. 1 is a block diagram of a fuel cell device 100 of the embodiment. The fuel cell device 100 is constituted by a fuel injection port 1, a fuel tank 2, a pump (variable delivery pump) 3, an open/close valve 4, an inhalation/exhalation port 5, a fuel cell 6, a DC/DC converter 7, a rechargeable battery 8, an output port 9, a controller 10 and so on.

The fuel injection port 1 is an injection port which is so configured that the fuel tank 2 is supplied from the outside with fuel including hydrogen component such as ethanol through the fuel injection port 1. The fuel tank 2 is configured to store the fuel. The pump 3 is configured to variably regulate an amount of fuel supply to the fuel cell 6. The open/close valve 4 is configured to open and close the inhalation/exhalation port 5. The inhalation/exhalation port 5 is configured to inhale oxygen (air) into the fuel cell 6 and to exhale moisture generated by the fuel cell 6.

While the fuel cell device 100 is working, the fuel cell 6 is supplied with fuel and oxygen so as to generate electric power and water, to output the electric power as a cell output 6a and to exhale the water (moisture) through the inhalation/exhalation port 5. A cell voltage V of the fuel cell 6a may change its value depending on the amount of the fuel supply or on a load current fluctuation. If the fuel cell device 100 stops working, the fuel and oxygen supply to the fuel cell 6 is cut off so that the fuel cell 6 stops generating power.

The DC/DC converter 7 is a voltage up converter configured to raise the cell output 6a to a certain constant voltage, and to output the constant voltage through the output port 9. The DC/DC converter 7 is configured to control battery charging and to charge the rechargeable battery 8.

The rechargeable battery 8 is an auxiliary power supply and is connected in parallel with the DC/DC converter 7. In a case where an output of the DC/DC converter 7 is not obtained after the fuel cell 6 was stopped, the rechargeable battery 8 can supply an external load (not shown) such as a mobile phone, and a VDD terminal of the controller 10 with power. The fuel cell device 100 does not necessarily have the rechargeable battery 8 built-in, and in that case the VDD terminal of the controller 10 may be supplied with power from an externally connected device.

It is not preferable for a system using the fuel cell device 100 that the rechargeable battery 8, if having only a small capacity to be charged, discharges electric power and is exhausted soon. Thus, it is necessary that the fuel cell 6 be able to start working immediately.

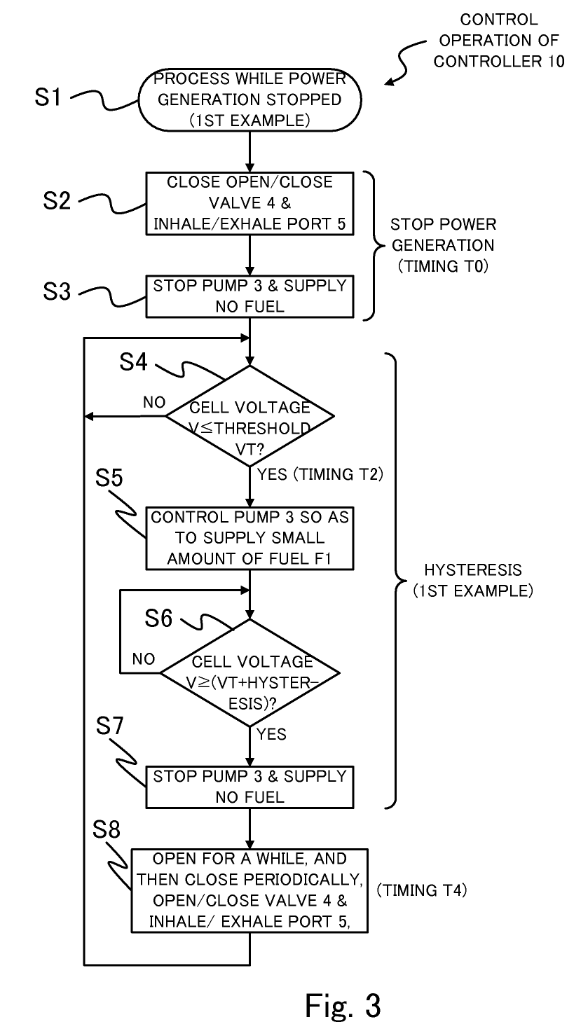

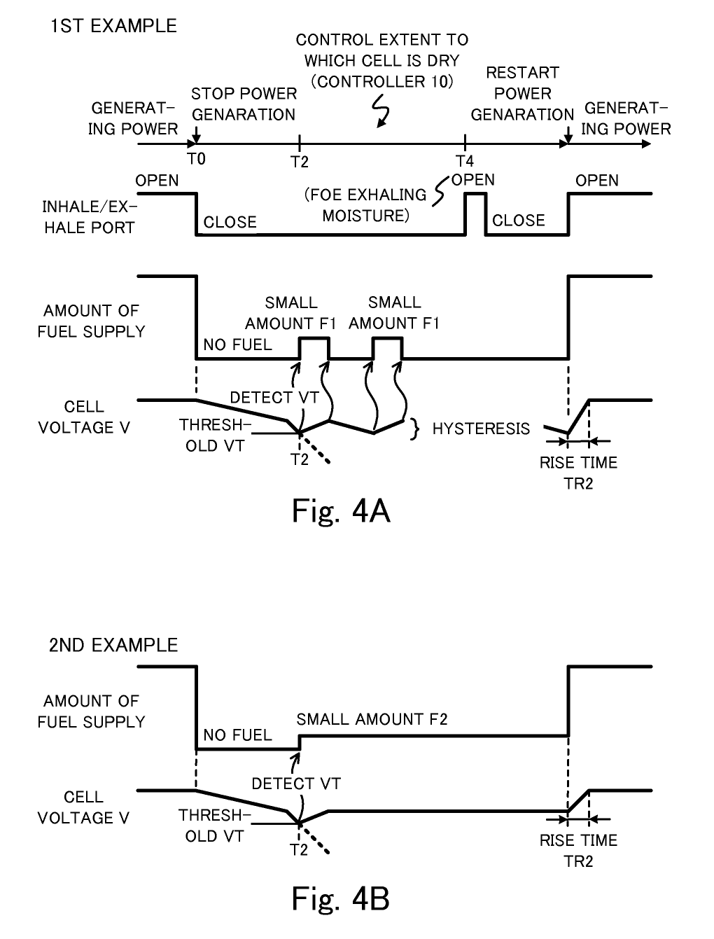

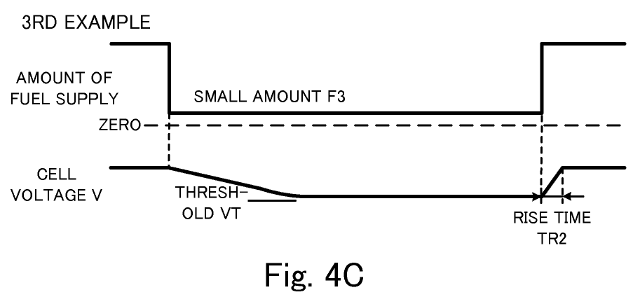

The controller 10 is configured to control the pump 3 and the open/close valve 4 so as to control the power generation of the fuel cell 6. The control of the controller 10 of the present invention will be described later with reference to FIGS. 3-4.

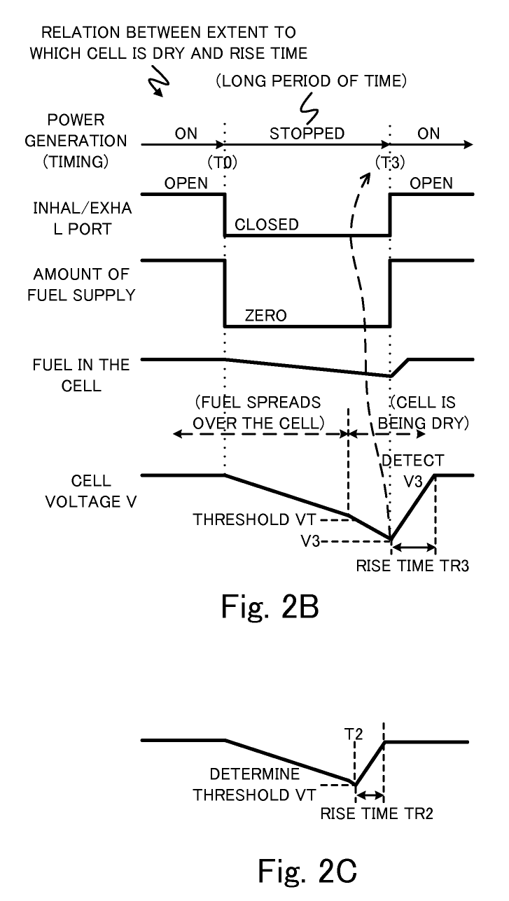

FIGS. 2A and 2B illustrate an experiment with respect to a relation between the extent to which the inside of the fuel cell 6 is dry and a rise time of the fuel cell 6. FIG. 2A shows a case where power generation is stopped for a short period of time. FIG. 2B shows a case where power generation is stopped for a long period of time. FIG. 2C shows a threshold voltage VT that the control of the present invention is based on.

FIG. 2A shows a case where power generation is stopped for a short period of time. As shown in FIG. 2A, before a timing T0 while power is being generated, the inhalation/exhalation port 5 is open so that the supplied fuel spreads all over the fuel cell 6.

At the timing T0, the fuel cell device 100 closes the inhalation/exhalation port 5 so as to be supplied with no fuel and stops generating power. After the power generation is stopped, the fuel that spreads all over and a little amount of oxygen (air) still remain in the fuel cell 6, and some oxygen (air) leaks into the fuel cell 6. Owing to those ingredients, as a matter of fact, the fuel cell device 100 gradually continues generating power instead of completely stopping generating power. Meanwhile, the amount of the fuel remaining in the fuel cell 6 gradually decreases, and the cell voltage V gradually decreases.

In FIG. 2A, if the cell voltage V decreases to a certain value V1 (at a timing T1), the fuel cell device 100 restarts generating power. As the period of time for which the power generation is stopped is still short at the timing T1, the fuel still spreads over the fuel cell 6. Thus, the fuel cell device 100 immediately gives full scope to its ability to generate power, and the cell voltage V returns to a former value after a short rise time TR1.

FIG. 2B shows a case where power generation is stopped for a long period of time. If the period of time for which power generation is stopped is long, the fuel cell 6 starts to be dry, and the cell voltage V rapidly decreases in parallel. If the cell voltage V decreases to a certain value V3 (at a timing T3), the period of time for which power generation is stopped has been so long that the fuel cell 6 has started to be dry.

In FIG. 2B, if the cell voltage V decreases to the value V3 (at the timing T3), the fuel cell device 100 restarts generating power. Although the fuel cell 6 is supplied with fuel, it takes several to dozens of minutes before the fuel spreads over the fuel cell 6. Meanwhile, the fuel cell device 100 does not give full scope to its ability to generate power, and the cell voltage V returns to its former value after a long rise time TR3, which will not be allowed by a system using the fuel cell device 100.

FIG. 2C shows how the threshold voltage VT that the control of the present invention is based on is determined by an experiment. As described with reference to FIGS. 2A and 2B, the cell voltage V is set as a parameter, and a relation between the threshold voltage VT and the rise time is found through the experiment. Then, a lowest value of the cell voltage V corresponding to a rise time that is short enough to be allowed by the system using the fuel cell device 100 is determined as the threshold voltage VT.

That is, the threshold voltage VT is between the values V1 and V3. If the fuel cell device 100 restarts generating power at a timing T2 at which the cell voltage V decreases to the threshold voltage VT, the cell voltage V returns to its former value after a short rise time TR2. It means that the fuel cell 6 has not yet been so dry to affect the rising process at the timing at which the cell voltage V decreases to the threshold voltage VT.

The above experiment is not to directly observe the amount of the residual fuel or a state of being dry, but to pay attention to a change, caused by a dry state in the fuel cell 6, of the relation between the cell voltage V while the power generation is stopped and the rise time of the cell voltage V after the power generation restarts.

As representing the ability of the fuel cell 6 to start to generate power, the rise time of the cell voltage V is checked as described above. Instead, output power (volt times ampere) of the fuel cell 6 may be checked. That is, the threshold voltage VT may be determined by paying attention to a change, caused by the dry state in the fuel cell 6, of a relation between the cell voltage V while the power generation is stopped and a rise time of the output power after the power generation restarts.

As described above, the controller 10 is given the threshold voltage VT as a standard so as to perform a control operation, which will be described in detail with reference to FIGS. 3-4C. FIG. 3 is a flowchart of a first example of the control operation performed by the controller 10 of the fuel cell device 100 of the embodiment of the invention. Only the first example is explained with reference to a flowchart.

FIGS. 4A-4C are timing charts for illustrating the first example, a second example and a third example of the control operation of the controller 10 of the fuel cell device 100, respectively.

The controller 10 performs the first to third examples of the control operation while the power generation is stopped. The controller 10 controls the fuel supply in such a way that the fuel cell 6 is supplied with a very small amount of the fuel in order not to make the fuel cell 6 so dry as to affect the rising process. It is a feature of the above control operation that the inhalation/exhalation port 5 is closed.

As shown in FIG. 4A of the first example, the controller 10 starts a process while the power generation is stopped (step S1). That is, the controller 10 closes the open/close valve 4 and the inhalation/exhalation port 5 (step S2), and stops the pump 3 so as to supply no fuel (step S3) (timing T0).

The controller 10 compares the cell voltage V with the threshold voltage VT that is determined beforehand (step S4). If the cell voltage V is no greater than the threshold voltage VT (timing T2), the controller 10 controls the pump 3 so as to supply the fuel cell 6 with a very small amount of the fuel F1 (step S5). Then, although the inhalation/exhalation port 5 is closed, the cell voltage V gradually increases due to a very small amount of power generation caused by oxygen (air) leakage and so on.

Then, the controller 10 compares the cell voltage V with a sum of the threshold voltage VT and a hysteresis component (step S6). If the cell voltage V is no less than the sum of the threshold voltage VT and the hysteresis component, the controller 10 stops the pump 3 and supplies no fuel (step S7).

The above steps S4-S7 are repeated in a loop so that the small amount of the fuel F1 is repeatedly supplied and not supplied, and that the cell voltage V is kept equal to or around the threshold voltage VT. As a very small amount of power is generated in the loop, the controller 10 periodically opens the open/close valve 4, opens the inhalation/exhalation port 5 for a certain period of time so as to exhale moisture and then closes the open/close valve 4 (step S8) (timing T4).

After a power generation process restarts (not shown in the flowchart) (timing T5), the rise time TR2 that is short enough can be obtained as described with reference to FIG. 2.

The controller 10 repeats the process for supplying and not supplying the small amount of the fuel F1 by taking the hysteresis into account. The controller 10 may finely control an amount of the fuel supply such as controlled by an inverter.

According to the above first example, while the power generation is stopped, the controller 10 keeps the inhalation/exhalation port 5 closed so as to prevent the power generation. Meanwhile, the controller 10 supplies a very small amount of the fuel so that the cell voltage V is kept equal to or around the threshold voltage VT. If the power generation restarts, the rise time TR2 that is short enough can be obtained, thereby.

Next, the second example shown in FIG. 4B will be explained. A flowchart of the second example is omitted. The controller 10 of the first example repeats the process for supplying and not supplying the small amount of the fuel F1 by taking the hysteresis into account, if the cell voltage V is no greater than the threshold voltage VT (timing T2). The controller 10 of the second example keeps supplying a small amount of the fuel F2 after once detecting the cell voltage V being no greater than the threshold voltage VT (timing T2).

The small amount of the fuel F2 is an amount of fuel supply upon the controller 10 determining the extent to which to regulate the pump 3 through an experiment beforehand so that the cell voltage V can remain around the threshold voltage VT.

According to the second example, while the power generation is stopped, the controller 10 keeps the inhalation/exhalation port 5 closed so as to prevent the power generation. Meanwhile, the controller 10 supplies a very small amount of the fuel so that the cell voltage V is kept around the threshold voltage VT. If the power generation restarts, the rise time TR2 that is short enough can be obtained, thereby.

Next, the third example shown in FIG. 4C will be explained. A flowchart of the third example is omitted. The controller 10 of the third example does not check the threshold voltage VT. The controller 10 keeps supplying a small amount of the fuel F3 at the timing T0 of the stop of the power generation instead of supplying no fuel.

The small amount of the fuel F3 is an amount of fuel supply upon the controller 10 determining the extent to which to regulate the pump 3 through an experiment beforehand so that the cell voltage V can remain around the threshold voltage VT.

According to the third example, while the power generation is stopped, the controller 10 keeps the inhalation/exhalation port 5 closed so as to prevent the power generation. Meanwhile, the controller 10 supplies a very small amount of the fuel so that the cell voltage V is kept equal to or around the threshold voltage VT. If the power generation restarts, the rise time TR2 that is short enough can be obtained, thereby.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A fuel cell device, comprising:
a fuel cell;
a pump configured to regulate fuel supply to the fuel cell;
an inhalation/exhalation port configured to inhale oxygen and exhale moisture into and from the fuel cell, respectively; and
a controller configured to open and close the inhalation/exhalation port, the controller being configured to control the pump so as to supply the fuel cell with fuel while the inhalation/exhalation port is closed in such a way that the fuel cell keeps an output voltage equal to or around a determined threshold value.

2. The fuel cell device of claim 1, wherein the controller is further configured to control the pump so that the fuel cell produces an output showing a rise time no longer than a determined period of time after the inhalation/exhalation port is opened.

3. The fuel cell device of claim 1, wherein the controller is further configured to control the pump so as to start to supply the fuel cell with fuel while the inhalation/exhalation port is closed upon the output voltage of the fuel cell being lower than the threshold value, and to stop supplying the fuel cell with fuel while the inhalation/exhalation port is closed upon the output voltage of the fuel cell being greater than a sum of the threshold voltage and a hysteresis component.

4. The fuel cell device of claim 1, wherein the controller is further configured to control the pump so as to supply the fuel cell with a constant amount of fuel after the output voltage of the fuel cell becomes lower than the threshold value and while the inhalation/exhalation port is closed.

5. The fuel cell device of claim 1, wherein the controller is further configured to control the pump so as to supply the fuel cell with a constant amount of fuel while the inhalation/exhalation port is closed.

6. The fuel cell device of claim 2, wherein the controller is further configured to control the pump so as to start to supply the fuel cell with fuel while the inhalation/exhalation port is closed upon the output voltage of the fuel cell being lower than the threshold value, and to stop supplying the fuel cell with fuel while the inhalation/exhalation port is closed upon the output voltage of the fuel cell being greater than the threshold voltage plus a hysteresis component.

7. The fuel cell device of claim 2, wherein the controller is further configured to control the pump so as to supply the fuel cell with a constant amount of fuel after the output voltage of the fuel cell becomes lower than the threshold value and while the inhalation/exhalation port is closed.

8. The fuel cell device of claim 2, wherein the controller is further configured to control the pump so as to supply the fuel cell with a constant amount of fuel while the inhalation/exhalation port is closed.

9. A method for regulating fuel supply to a fuel cell device, the fuel cell device having an inhalation/exhalation port configured to inhale oxygen and exhale moisture into and from the fuel cell, respectively, comprising:
closing the inhalation/exhalation port; and
supplying the fuel cell with fuel while the inhalation/exhalation port is closed in such a way that the fuel cell keeps an output voltage equal to or around a determined threshold value.

10. The method for regulating the fuel supply of claim 9, wherein the fuel cell is supplied with fuel while the inhalation/exhalation port is closed so as to produce an output showing a rise time no longer than a determined period of time after the inhalation/exhalation port is opened.

11. The method for regulating the fuel supply of claim 9, wherein the fuel cell starts to be supplied with fuel while the inhalation/exhalation port is closed upon the output voltage of the fuel cell being lower than the threshold value, and the fuel cell stops being supplied with fuel while the inhalation/exhalation port is closed upon the output voltage of the fuel cell being greater than a sum of the threshold voltage and a hysteresis component.

12. The method for regulating the fuel supply of claim 9, wherein the fuel cell is supplied with a constant amount of fuel after the output voltage of the fuel cell becomes lower than the threshold value and while the inhalation/exhalation port is closed.

13. The method for regulating the fuel supply of claim 9, wherein the fuel cell is supplied with a constant amount of fuel while the inhalation/exhalation port is closed.

14. The method for regulating the fuel supply of claim 10, wherein the fuel cell starts to be supplied with fuel while the inhalation/exhalation port is closed upon the output voltage of the fuel cell being lower than the threshold value, and the fuel cell stops being supplied with fuel while the inhalation/exhalation port is closed upon the output voltage of the fuel cell being greater than the threshold voltage plus a hysteresis component.

15. The method for regulating the fuel supply of claim 10, wherein the fuel cell is supplied with a constant amount of fuel after the output voltage of the fuel cell becomes lower than the threshold value and while the inhalation/exhalation port is closed.

16. The method for regulating the fuel supply of claim 10, wherein the fuel cell is supplied with a constant amount of fuel while the inhalation/exhalation port is closed.
